(19) United States
(12) Patent Application Publication
(10) Pub. No.: US 2026/0238721 A1
(43) Pub. Date: Aug. 13, 2026

(54) GETS CALL PIN SHARING VIA IMS DATA CHANNEL

(71) Applicant: T-Mobile USA, Inc., Bellevue, WA (US)

(72) Inventors: Jagannadha Anudeep Varma Datla, Kent, WA (US); Harikishore Allu Balan, Lynnwood, WA (US); Mark J. Bonn, Granite Bay, CA (US); Nauhman N Gora, Irvine, CA (US); Mallika S Deshpande, Sammamish, WA (US); Joel L Arends, Renton, WA (US); A. Karl Corona, Maple Valley, WA (US)

(21) Appl. No.: 19/051,105

(22) Filed: Feb. 11, 2025

Related U.S. Application Data
(63) Continuation of application No. 19/051,073, filed on Feb. 11, 2025.

(51) Int. Cl. H04M 3/42; H04M 7/12

(52) U.S. Cl. CPC H04M 3/42187; H04M 7/123; H04M 2203/6045; H04M 2242/04

(57) ABSTRACT

As described herein, an application server (e.g., a government emergency telecommunications service (GETS) server or originating telephony application server (O-TAS) sends a request to an Internet protocol multimedia subsystem (IMS) data channel (DC) node for an IMS DC associated with a user equipment (UE). The application server sends the request in response to a GETS call from the UE. The application server then sends a message to the UE inviting the UE to the IMS DC, leading to establishment of the IMS DC. The IMS DC node then receives a personal identification number (PIN) and destination number from the UE and sends the PIN and destination number to the GETS server. The GETS server authenticates the PIN and reinvites the UE toward the destination number to enable call setup completion for a call between the UE and destination number.

### RELATED APPLICATION

This application is a continuation of, and claims priority to, currently pending U.S. patent application Ser. No. 19/051,073, filed on Feb. 11, 2025, which is fully incorporated by reference herein.

### BACKGROUND

Government emergency telecommunications service (GETS) calls are initially placed to a GETS number and, after authentication of a personal identification number (PIN) entered by the user, are connected to an intended call recipient. Placing these GETS calls can be difficult, as the PIN is a fifteen-digit number that must be manually entered by the user on the user's device. The chance of a typographic error is high, and the PIN entry is time consuming. Any error can result in failure to authenticate and the need to reenter the entire PIN.

Internet protocol multimedia subsystem (IMS) data channel (DC) supports packet-switched calls and communications by providing an additional data channel for those calls/communications that can transmit data (videos, applications, PINs) transparently, reducing the need for user involvement but ensuring that data is coming from, e.g., the user's device.

### BRIEF DESCRIPTION OF THE DRAWINGS

The detailed description is set forth with reference to the accompanying figures. In the figures, the left-most digit(s) of a reference number identifies the figure in which the reference number first appears. The same reference numbers in different figures indicate similar or identical items.

FIG. 1 is a network diagram showing a telecommunications network having at least an application server (e.g., a government emergency telecommunication service (GETS) server, an originating telephony application server (O-TAS), etc.) and Internet protocol multimedia subsystem (IMS) data channel (DC) node(s) and showing a user equipment (UE) that provides a personal identification number (PIN) and destination number through the IMS DC, and in response to authentication of the PIN, completes setup of a call with a destination number UE.

FIG. 2 is a call flow diagram showing messages among a UE, GETS server, IMS DC node, and destination number UE for establishing an IMS DC between the UE and GETS server, authenticating a PIN from the UE, and completing setup of a call between the UE and the destination number UE.

FIG. 3 is a call flow diagram showing messages among a UE, O-TAS, GETS server, IMS DC node, and destination number UE for establishing an IMS DC among the UE, the O-TAS, and the GETS server, authenticating a PIN from the UE, and completing setup of a call between the UE and the destination number UE.

FIG. 4 is a flow diagram of an illustrative process for a UE to make a GETS call to a GETS number, receive in response a message inviting the UE to establish an IMS DC between the GETS server and UE through an IMS DC node, provide a PIN and destination number to the GETS server through the IMS DC, and, upon authentication of the PIN by the GETS server, complete setup of a call with the destination number.

FIG. 5 is a flow diagram of an illustrative process for a GETS server to receive a call initiation message from a UE, send a request to an IMS DC node to establish an IMS DC between the UE and the GETS server, send a message to the UE inviting the UE to the IMS DC through the IMS DC node, receive a PIN and destination number from the UE through the IMS DC, authenticate the PIN, and reinvite the UE toward a call with the destination number.

FIG. 6 is a flow diagram of an illustrative process for an IMS DC node to establish an IMS DC between a UE and a GETS server and, through the IMS DC, to receive a PIN and destination number from the UE and to send the PIN and destination number to the GETS server.

FIG. 7 is a flow diagram of an illustrative process for an O-TAS to receive a call initiation message from a UE, send one or more requests for IMS DC associated with at least the UE and a GETS server to an IMS DC node, and send messages to the UE and the GETS server inviting the UE and the GETS server to the IMS DC.

FIG. 8 is a flow diagram of an illustrative process for a GETS server to receive from an O-TAS an invitation to an IMS DC with a UE, establish the IMS DC with the UE through an IMS DC node, receive a PIN and destination number from the UE through the IMS DC, authenticate the PIN, and reinvite the UE toward a call with the destination number.

FIG. 9 is a flow diagram of an illustrative process for an IMS DC node to establish an IMS DC among at least a UE and a GETS server in response to communications from an O-TAS and, through the IMS DC, to receive a PIN and destination number from the UE and to send the PIN and destination number to the GETS server.

FIG. 10 is a schematic diagram of a computing device capable of implementing functionality of at least one of the UE, the O-TAS, the GETS server, or the IMS DC node.

### DETAILED DESCRIPTION

This disclosure is directed in part to use of an Internet protocol multimedia subsystem (IMS) data channel (DC) between at least a user equipment (UE) and a government emergency telecommunications service (GETS) server to send a personal identification number (PIN) from the UE to the GETS server in association with a GETS call from the UE. In some implementations, the IMS DC is initiated by an application server (e.g., the GETS server or an originating telephony application server (O-TAS)) sending a request to an IMS DC node in response to a GETS call from the UE. The IMS DC node then responds to the application server, causing it to send a message to the UE inviting the UE to the IMS DC. After establishing the IMS DC, the IMS DC node receives the PIN and a destination number from the UE and sends the PIN and destination number to the GETS server. The GETS server then authenticates the PIN. Following authentication of the PIN, the GETS server reinvites the UE toward the destination number to enable call setup completion for a call between the UE and destination number.

In further implementations, before the UE sends the PIN and destination number to the IMS DC node, the UE authenticates its user. It may do so, for example, through the use of biometric(s) or other mechanism that may, in some circumstances, be transparent to the user. Additionally, the user may have previously entered the PIN—e.g., the first time a GETS call is placed—or may have been received from a telecommunications network or device manufacturer, with or without user input. In some examples, the PIN and a biometric standard may be received from the IMS DC node when the IMS DC is established. The IMS DC node may also transmit an application via the IMS DC that can be installed and used by the UE to authenticate the user and send the PIN and destination number. In other examples, the application may have been previously downloaded to the UE by the user (e.g., from an app store) or by the network operator. In yet further examples, the native dialer of the UE may perform the operations described herein for the application.

While the authentication and transmission of PIN and destination number may be transparent to the user, the user, in some implementations, may also select one or both of the PIN and destination number responsive to authentication. If multiple PINs are stored, the user can select which PIN to send. The user can also navigate to a destination number collection to the select the destination number or can enter the destination number. The destination number collection can be part of an address book/contacts, can be pre-saved data, can be maintained by the native dialer, etc.

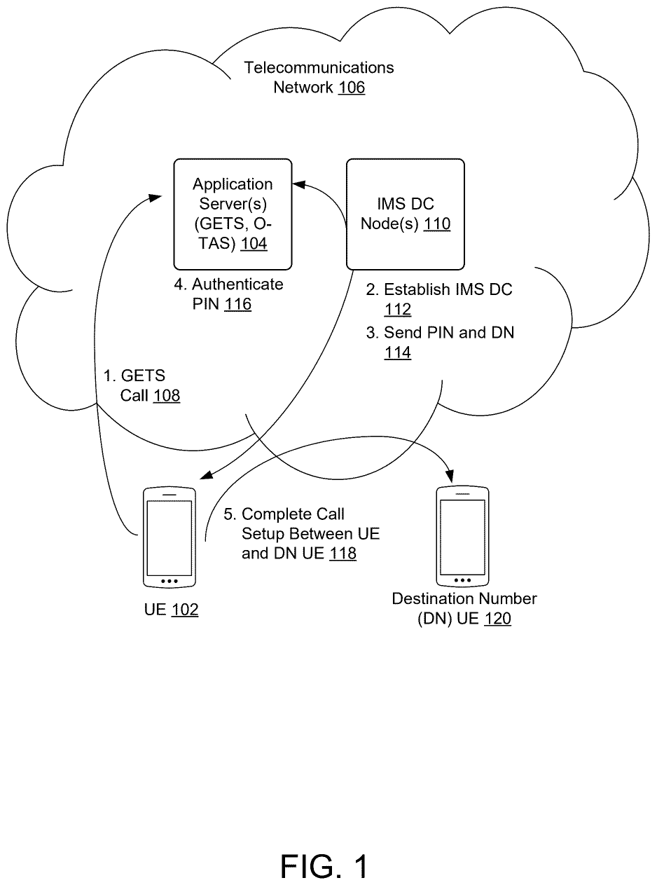

FIG. 1 is a network diagram showing a telecommunications network having at least an application server (e.g., a GETS server, an O-TAS, etc.) and IMS DC node(s) and showing a UE that provides a PIN and destination number through the IMS DC, and in response to authentication of the PIN, completes setup of a call with a destination number UE. As illustrated, a UE 102 and an application server 104 of a telecommunications network 106 may send/receive message for a GETS call 108. The GETS call 108 may result in the application server 104 and an IMS DC node 110 communicating to establish an IMS DC 112 between a GETS server (e.g., the application server 104) and the UE 102. The UE 102 provides at 114 its PIN and a destination number via the IMS DC 112 to the GETS server which, at 116, authenticates the PIN. Based on the authentication, the GETS server sends a message to the UE 102 re-inviting the UE 102 towards a call 118 with the destination number UE 120.

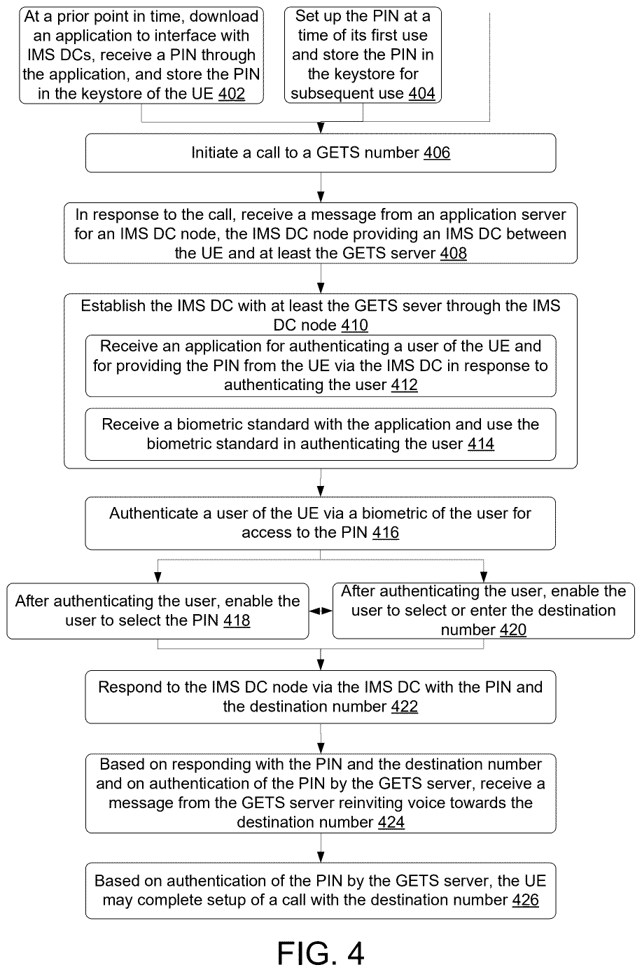

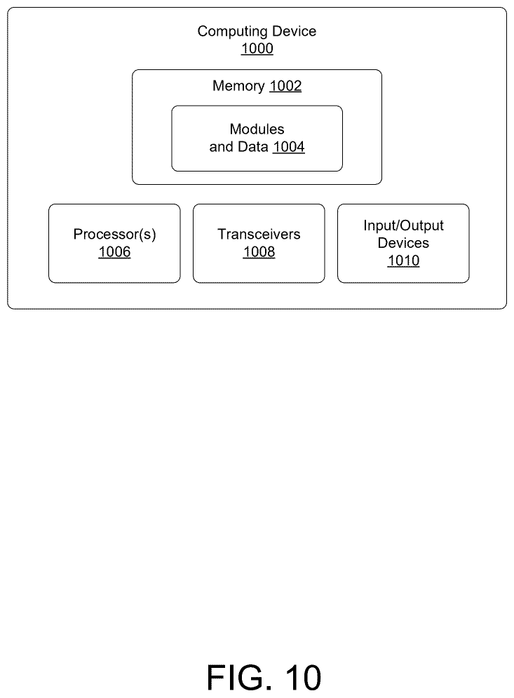

The UE 102 may be any sort of wireless communication device, such as a cellular phone, a tablet computer, an Internet-of-Things (IoT) device (e.g., a watch, glasses, goggles, etc.), a gaming device, etc. The user of the UE 102 may subscribe for services of a network operator of the telecommunications network 106. Further, the UE 102 may include application(s) for use over the telecommunications network, such as a native dialer, other calling application(s), messaging application(s), browsing application(s), etc., as well as platform functionality for connecting to and communicating over the telecommunications network 106. The destination number UE 120 may also be similar to the UE 102 in any of the ways described above. Alternatively, the destination number UE 120 may be a fixed location device, such as a business or home phone located in a specific physical location, or a fixed location computing device. An example UE 102 is shown in FIG. 10 and is described below in detail with reference to that figure. Example operations of the UE 102 are shown in FIG. 4 and are described below in detail with reference to that figure.

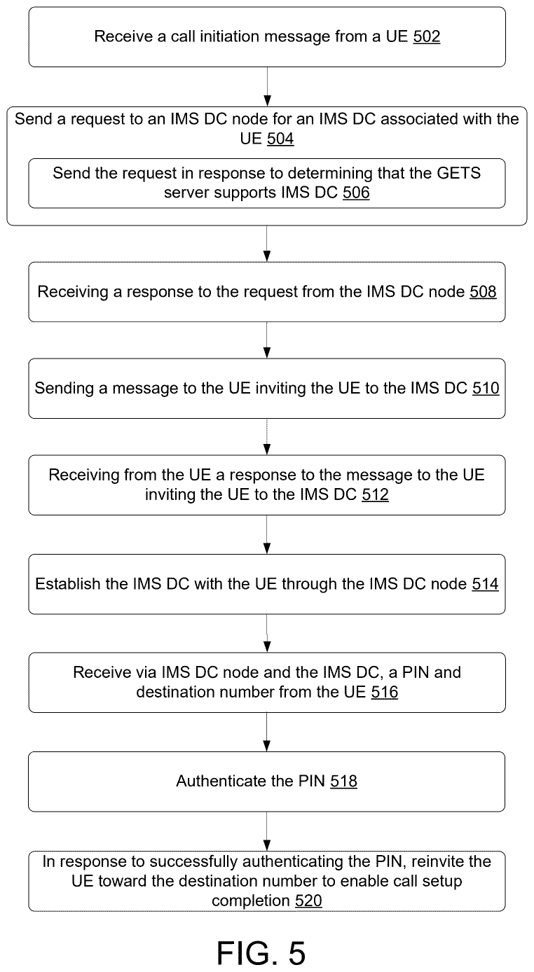

The applications server 104 may be implemented in any sort of computing device(s), either directly or through virtual device(s) on top of physical computing device(s). While FIG. 1 shows a single “application server 104”, it is to be understood that the application server 104 may represent either a GETS server alone or both a GETS server and an O-TAS (either co-located or located on different physical devices). Functionality of the applications server 104 as a GETS server includes receiving calls to a GETS number (e.g., a 1-800 number), receiving a PIN from the calling UE, authenticating the PIN, and, when the PIN authenticates, enabling the calling UE to proceed with establishing a call to a destination number (e.g., to destination number UE 120). In some implementations, the GETS server may have a data store of acceptable PINs (and/or unacceptable PINs) for use in authentication. Also, while applications server 104 is shown as part of the telecommunications network 106, and while it may be a part of the telecommunications network 106, in other examples the applications server 104 may be external to the telecommunications network 106 and communicate with the telecommunications network 106 through a gateway node/function of the telecommunications network 106. An example applications server 104 is shown in FIG. 10 and is described below in detail with reference to that figure. Example operations of the applications server 104 are shown in FIGS. 5, 7, and 8 and are described below in detail with reference to those figures.

The telecommunications network 106 may include a core network and access network(s). The access networks may include any one or more base stations or other wireless access points for wireless communication with at least the UE 102 and the destination number UE 120. The access networks may be connected to the core network through a wired and/or wireless backhaul. The core network may include components such as a user plane function (UPF), a service management function (SMF), an access and mobility management function (AMF), a network repository function (NRF), a unified data management (UDM) node/function, charging function (CHF), etc. These names each reflect specific generation(s) of cellular technology; it is to be understood that they also represent/cover their predecessor and successor nodes/functions (in prior or later generations) with same or similar purposes. The telecommunications network 106 may also include an IMS. The IMS may include call session control functions (CSCF), such as a proxy CSCF (P-CSCF), a serving CSCF (S-CSCF), and an interrogating CSCF (I-CSCF), as well as telephony application servers, which the application server 104 may be one of (e.g., as an O-TAS). Further, as shown in FIG. 1, the telecommunications network 106 may include the application server 104 and the IMS DC node(s) 110.

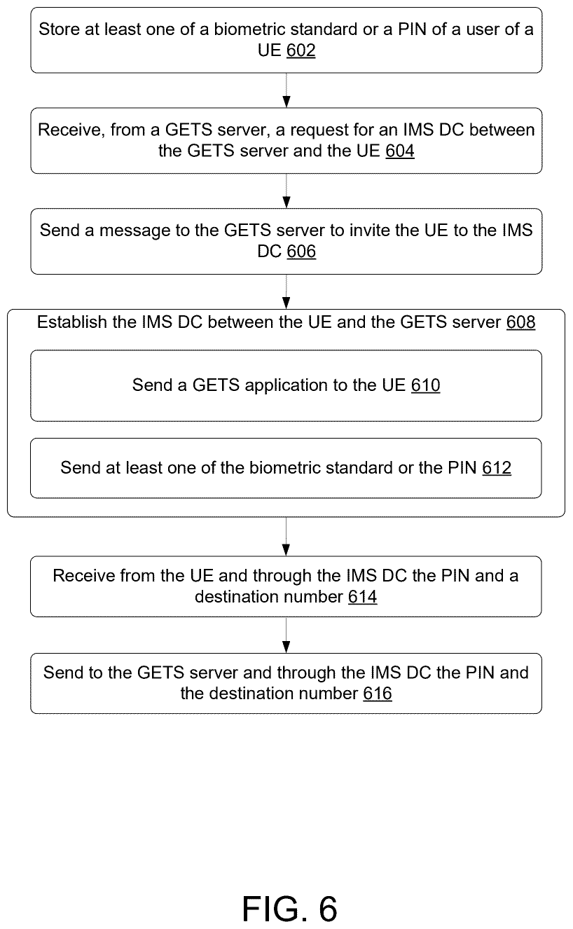

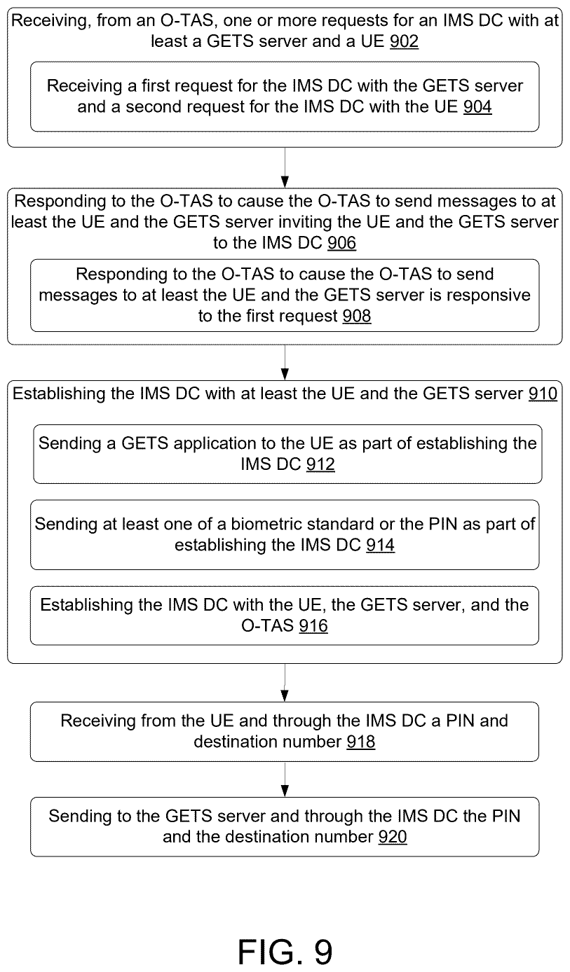

In various implementations, the IMS DC node(s) 110 may be one or more computing devices implementing multiple functions, such as an application server, an application data repository, etc. that collectively provide IMS DC services to the telecommunications network 106 and to the devices connected to the telecommunications network 106 (such as UE 102 and destination number UE 120). The IMS DC node(s) 110 may provide a third channel for, e.g., active calls. This third channel is referred to herein as the IMS DC. IMS DC and their supporting nodes may conform to one or more standards, such as GSMA NG .134. As described herein, the IMS DC node(s) 110 may receive a request for an IMS DC from the application server 104, may establish, at 112, the IMS DC between the UE 102 and the GETS server, and may receive and provide, at 114, a PIN and destination number from the UE 102 to the GETS server via the IMS DC. An example IMS DC node 110 is shown in FIG. 10 and is described below in detail with reference to that figure. Example operations of the IMS DC node 110 are shown in FIGS. 6 and 9 and are described below in detail with reference to those figures.

In some implementations, the UE 102 may have downloaded a client application for IMS DC and/or GETS calling at a prior point in time. Such a client application may have been downloaded from an application store, via a prior IMS DC from a prior GETS call, as part of a platform update, etc. The user of the UE 102 may have set up the client application at that time, selecting or providing a PIN, adding destination numbers, etc.

In further implementations, the UE 102 may lack a client application but have the PIN and/or destination number(s) stored from a prior use. For example, the first time the user of the UE 102 calls the GETS number and enters a PIN, that PIN may be stored for future use.

As illustrated in FIG. 1, the user of the UE 102 may at some time be connected to the telecommunications network 106 a place a call 108 to a GETS number (e.g., a specific 1-800 number) that results in call messages to the application server 104. When the application server 104 receives the messages for the call 108, the application server 104 may determine whether the GETS server supports IMS DC. Alternatively, the configuration of the application server 104 may assume support of IMS DC. In either case, when IMS DC is supported, the application server 104 may request that the IMS DC node(s) 110 set up an IMS DC, at 112 between at least the GETS server and the UE 102 (and if the application server 104 includes an O-TAS, the IMS DC may be with the O-TAS, too). If the GETS server does not support IMS DC, the application server 104 may contact the UE 102 directly and request input by, e.g., a user of the UE 102 of the PIN (e.g., manual PIN entry).

In various implementations, the IMS DC node(s) 110 may respond to the application server 104 to cause the application server 104 to send a message to the UE 102 (e.g., a session initiation protocol (SIP) RE-INVITE message). After the UE 102 responds, the IMS DC node(s) 110, the UE 102, and the application server 104 (GETS server, O-TAS, etc.) may establish, at 112, the IMS DC. In some examples, the IMS DC node(s) 110 may send the client application to the UE 102 as part of establishing, at 112, the IMS DC, transparently from the perspective of the user of the UE 102, which the UE 102 may automatically install. Additionally, the PIN and/or destination number may be transmitted with the client application. The PIN and/or destination number may be stored by the IMS DC node(s) 110, by the application server 104, or by another data repository of the telecommunications network 106.

Upon receiving the establishing, at 112, the IMS DC (and possibly receiving the client application, PIN, and/or destination number), the UE 102 may authenticate the user of the UE 102. Such authentication could involve, for example, a biometric that could be obtained transparently to the user or with user involvement and compared to a biometric standard (which could be maintained on the UE 102 or receive from the IMS DC node(s) 110 and/or other node(s) of the telecommunications network 106). After authenticating the user, the user of the UE 102 may select the PIN from among multiple PINs and/or select the destination number from among multiple destination numbers (e.g., from an address book, contact list, etc.). In some examples, the PIN and destination number may then be sent, at 114 via the IMS DC, through the IMS DC nodes(s) 110, to the GETS server.

In some implementations, the GETS server may authenticate the PIN at 116, upon receiving the PIN via the IMS DC. When the PIN is authenticated, the GETS server may send a message, such as a SIP RE-INVITE to the UE 102 to enable the UE 102 to establish a call, at 118 with the destination number UE 120.

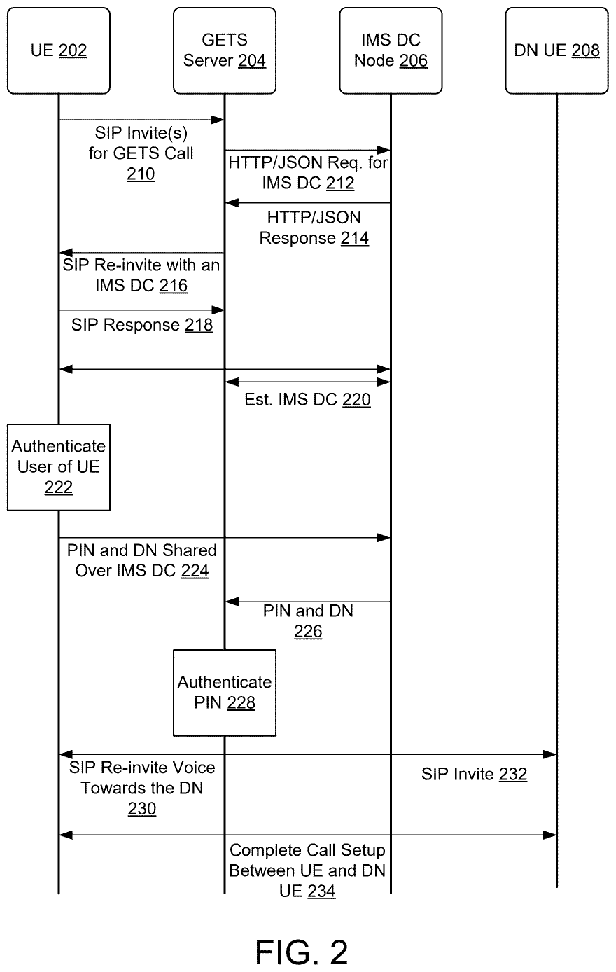

FIG. 2 is a call flow diagram showing messages among a UE, GETS server, IMS DC node, and destination number UE for establishing an IMS DC between the UE and GETS server, authenticating a PIN from the UE, and completing setup of a call between the UE and the destination number UE. As shown, a UE 202, GETS server 204, IMS DC node 206, and destination number UE 208 may exchange messages and perform operations leading to the sharing of a PIN from a UE 202 to the GETS server 204 over an IMS DC, authentication of the PIN, and establishing a call between the UE 202 and destination number UE 208.

In various implementations, the UE 202 may be an example of the UE 102, the GETS server 204 may be an example of the application server 104, the IMS DC node 206 may be an example of the IMS DC node 110, and the destination number UE 208 may be an example of the destination number UE 120.

As shown in FIG. 2, the UE 202 and GETS server 204 may exchange SIP invite message(s) 210 when the UE 202 places a call to a GETS number (e.g., a GETS phone number, such as a GETS 1-800 number).

In response to the SIP invite message(s), the GETS server 204 may determine whether the GETS server 204 support IMS DC. When the GETS server 204 does not support IMS DC, the GETS server 204 may respond to the UE 202 with a request for the UE 202 to enter a PIN, which is then sent to the GETS server 204 for authentication. As noted elsewhere herein, such PIN entry may be manual and prone to user error.

In other implementations, support for IMS DC may simply be assumed by the logic handling the GETS call. When the GETS server 204 determines that the GETS server 204 support IMS DC, or when the logic of the GETS server 204 assumes this, the GETS server 204 may send a request 212 for IMS DC to IMS DC node(s) 206—shown in FIG. 2 as “IMS DC node 206”. The request 212 may use as its control protocol service-based interface (SBI) based on HTTP/JSON. Further, the request 212 may specify the UE 202 as an endpoint for the IMS DC.

The IMS DC node 206 may then send response 214 to the GETS server 204 to cause the GETS server 204 to send a SIP re-invite message 216 for IMS DC to the UE 202. The UE 202 may respond to the SIP re-invite with a SIP response message 218 sent to the GETS server 204.

Following this exchange of messages, the IMS DC node 206, UE 202, and GETS server 204 may exchange messages 220 to establish the IMS DC among themselves. Along with these messages 220, the IMS DC node 206 may send any or all of a client application for the UE 202, a PIN, a destination number, and/or a biometric standard. These additional items may be stored by the one or more of the IMS DC node 206, the GETS server 204, or other node(s) of the telecommunications network.

At 222, the UE 202 authenticates its user. It may do so using a biometric of the user which may be compared to a biometric standard stored by the UE 202 or received by the UE 202 (e.g., with messages 220 establishing the IMS DC). When the user is authenticated, the user may select the PIN and/or the destination number (or one or both may be automatically selected defaults).

Once the PIN and destination number are determined, they may be sent over the IMS DC to the IMS DC node 206 in a message 224 and from the IMS DC node 206 to the GETS server 204 in a message 226.

The GETS server may then, at 228, authenticate the PIN.

In response to the PIN authenticating, the GETS server 204 may send a SIP re-invite message 230 to the UE 202 for voice towards the destination number UE 208 and a SIP invite 232 to the destination number UE 208.

At 234, the UE 202 and destination number UE 208 may complete call setup and establish a call between themselves.

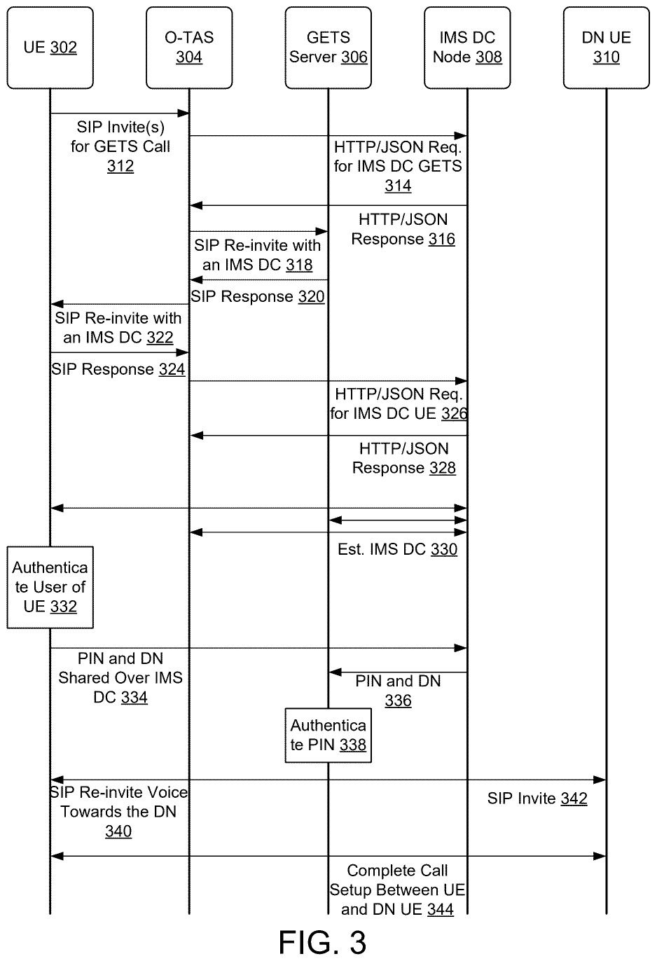

FIG. 3 is a call flow diagram showing messages among a UE, O-TAS, GETS server, IMS DC node, and destination number UE for establishing an IMS DC among the UE, the O-TAS, and the GETS server, authenticating a PIN from the UE, and completing setup of a call between the UE and the destination number UE. As shown, a UE 302, O-TAS 304, GETS server 306, IMS DC node 308, and destination number UE 310 may exchange messages and perform operations leading to the sharing of a PIN from a UE 302 to the GETS server 306 over an IMS DC, authentication of the PIN, and establishing a call between the UE 302 and destination number UE 310.

In various implementations, the UE 302 may be an example of the UE 102, the O-TAS 304 and GETS server 306 may each be an example of the application server 104, the IMS DC node 308 may be an example of the IMS DC node 110, and the destination number UE 310 may be an example of the destination number UE 120.

As shown in FIG. 3, O-TAS 304 may receive (directly or indirectly) SIP invite message(s) 312 when the UE 302 places a call to a GETS number (e.g., a GETS phone number, such as a GETS 1-800 number).

In response to the SIP invite message(s), the O-TAS 304 may determine whether the GETS server 306 support IMS DC. When the GETS server 306 does not support IMS DC, the O-TAS 304 may respond to the UE 302 with a request for the UE 302 to enter a PIN, which is then sent to the GETS server 306 for authentication. As noted elsewhere herein, such PIN entry may be manual and prone to user error.

In other implementations, support for IMS DC may simply be assumed by the logic handling the GETS call. When the O-TAS 304 determines that the GETS server 306 supports IMS DC, or when the logic of the O-TAS 304 assumes this, the O-TAS 304 may send a request 314 for IMS DC to IMS DC node(s) 308—shown in FIG. 3 as “IMS DC node 308” and receive response 316 from the IMS DC node 308. The request 314 and response 316 may use as their control protocol SBI based on HTTP/JSON. Further, the request 314 may specify the UE 302 and GETS server 306 as endpoints for the IMS DC.

The O-TAS 304 may then send a SIP re-invite message 318 to the GETS server 306, receive a SIP response (e.g., a 200 OK message) 320 from the GETS server 306, send a SIP re-invite message 322 to the UE 302, and receive a SIP response (e.g., a 200 OK message) 324 from the UE 302. These messages 318-324 among the UE 302, O-TAS 304, and GETS server 306 may prepare those nodes for the IMS DC.

The O-TAS may then send a second request 326 for IMS DC to the IMS DC node 308 and receive a response 328, with both the second request 326 and response 328 using as their control protocol SBI based on HTTP/JSON. In some implementations, the first request 314 may be associated with the GETS server 306 as an endpoint and the second request 326 may be associated with the UE 302 as an endpoint.

Following this exchange of messages, the IMS DC node 308, UE 302, GETS server 306, and O-TAS 304 may exchange messages 330 to establish the IMS DC among at least the IMS DC node 308, UE 302, and GETS server 306 (and, optionally, with the O-TAS 304, too). Along with these messages 330, the IMS DC node 308 may send any or all of a client application for the UE 302, a PIN, a destination number, and/or a biometric standard. These additional items may be stored by the one or more of the IMS DC node 308, the GETS server 306, or other node(s) of the telecommunications network.

At 332, the UE 302 authenticates its user. It may do so using a biometric of the user which may be compared to a biometric standard stored by the UE 302 or received by the UE 302 (e.g., with messages 330 establishing the IMS DC). When the user is authenticated, the user may select the PIN and/or the destination number (or one or both may be automatically selected defaults).

Once the PIN and destination number are determined, they may be sent over the IMS DC to the IMS DC node 308 in a message 334 and from the IMS DC node 308 to the GETS server 306 in a message 336.

The GETS server 306 may then, at 338, authenticate the PIN.

In response to the PIN authenticating, the GETS server 306 may send a SIP re-invite message 340 to the UE 302 for voice towards the destination number UE 310 and a SIP invite 342 to the destination number UE 310.

At 344, the UE 302 and destination number UE 310 may complete call setup and establish a call between themselves.

FIGS. 4-9 illustrate example processes. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

FIG. 4 is a flow diagram of an illustrative process for a UE to make a GETS call to a GETS number, receive in response a message inviting the UE to establish an IMS DC between the GETS server and UE through an IMS DC node, provide a PIN and destination number to the GETS server through the IMS DC, and, upon authentication of the PIN by the GETS server, complete setup of a call with the destination number. As illustrated at 402, at a prior point in time, the UE may download an application to interface with IMS DCs, receive a PIN through the application, and store the PIN in the keystore of the UE. Alternatively or additionally, at 404, the UE may set up the PIN at a time of its first use and store the PIN in the keystore for subsequent use.

At 406, the UE may initiate a call to a GETS number. As mentioned, the UE placing the GETS call may be a UE with a keystore for PINs. In some implementations, access to the keystore may be mediated by user authentication (e.g., via biometrics).

At 408, in response to the call, the UE may receive a message from an application server inviting the UE to an IMS DC through an IMS DC node, the IMS DC node providing an IMS DC between at least the UE and a GETS server. The application server may be an O-TAS or the GETS server.

At 410, the UE may establish the IMS DC with the GETS server through the IMS DC node. In some examples, the establishing includes receiving, at 412, an application for authenticating a user of the UE and for providing the PIN from the UE via the IMS DC in response to authenticating the user. Also, at 414, the UE may receive a biometric standard with the application and use the biometric standard in authenticating the user.

In some implementations, at 416, the UE may authenticate a user of the UE via a biometric of the user for access to the PIN. At 418, after authenticating the user, the UE may enable the user to select the PIN. At 420, also after authenticating the user, the UE may enable the user to select or enter the destination number.

At 422, the UE may respond to the IMS DC node via the IMS DC with the PIN and the destination number.

At 424, based on responding with the PIN and the destination number and on authentication of the PIN by the GETS server, the UE may receive a message from the GETS server reinviting voice towards the destination number.

At 426, also based on authentication of the PIN by the GETS server, the UE may complete setup of a call with the destination number.

In some implementations, at least one of the operations of the UE illustrated in FIG. 4 and described herein may be performed by a native dialer of the UE.

FIG. 5 is a flow diagram of an illustrative process for a GETS server to receive a call initiation message from a UE, send a request to an IMS DC node to establish an IMS DC between the UE and the GETS server, send a message to the UE inviting the UE to the IMS DC through the IMS DC node, receive a PIN and destination number from the UE through the IMS DC, authenticate the PIN, and reinvite the UE toward a call with the destination number. As illustrated at 502, the GETS server may receive a call initiation message from a UE.

At 504, the GETS server may then send a request to an IMS DC node for an IMS DC associated with the UE. At 506, the GETS server may send the request in response to determining that the GETS server supports IMS DC. In some implementations, when the GETS server does not support IMS DC, the GETS server may respond to the call initiation message by requesting that the UE enter the PIN.

At 508, the GETS server may receive a response to the request from the IMS DC node.

At 510, the GETS server may send a message to the UE inviting the UE to the IMS DC.

At 512, the GETS server may receive from the UE a response to the message to the UE inviting the UE to the IMS DC.

At 514, the GETS server may establish the IMS DC with the UE through the IMS DC node.

At 516, the GETS server may then receive via IMS DC node and the IMS DC, a PIN and destination number from the UE.

At 518, the GETS server may authenticate the PIN.

At 520, in response to successfully authenticating the PIN, the GETS server may reinvite the UE toward the destination number to enable call setup completion.

FIG. 6 is a flow diagram of an illustrative process for an IMS DC node to establish an IMS DC between a UE and a GETS server and, through the IMS DC, to receive a PIN and destination number from the UE and to send the PIN and destination number to the GETS server. As illustrated at 602, an IMS DC node may store at least one of a biometric standard or a PIN of a user of a UE.

At 604, the IMS DC node may receive from a GETS server a request for an IMS DC between the GETS server and the UE.

At 606, the IMS DC node may respond to the GETS server to cause the GETS server to send a message to the UE inviting the UE to the IMS DC.

At 608, the IMS node may then establish the IMS DC between the UE and the GETS server. At 610, the IMS DC node may send a GETS application to the UE as part of establishing the IMS DC. At 612, the IMS DC node may send at least one of the biometric standard or the PIN to the UE as part of establishing the IMS DC.

At 614, the IMS DC node may receive from the UE and through the IMS DC the PIN and a destination number.

At 616, the IMS DC node may then send to the GETS server and through the IMS DC the PIN and the destination number.

In various implementations, the communications to and from the IMS DC node may use HTTP/JSON as part of an SBI.

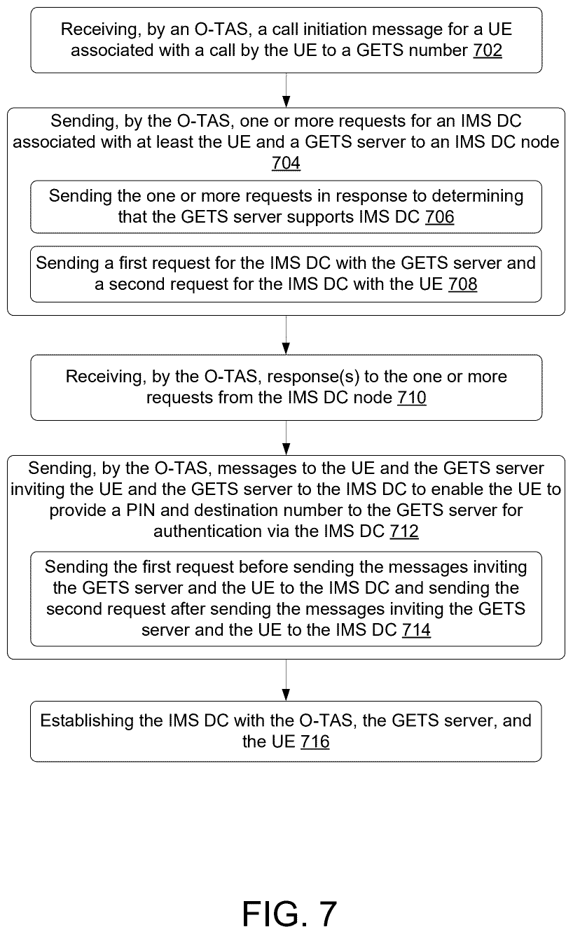

FIG. 7 is a flow diagram of an illustrative process for an O-TAS to receive a call initiation message from a UE, send one or more requests for IMS DC associated with at least the UE and a GETS server to an IMS DC node, and send messages to the UE and the GETS server inviting the UE and the GETS server to the IMS DC. At 702, the O-TAS may receive a call initiation message associated with a call by the UE to a GETS number.

At 704, the O-TAS may send one or more requests for an IMS DC associated with at least the UE and a GETS server to an IMS DC node. At 706, sending the one or more requests may comprise sending the one or more requests in response to determining that the GETS server supports IMS DC. In some implementations, when the GETS server does not support IMS DC, the O-TAS may respond to the call initiation message by requesting that the UE enter the PIN. At 708, sending the one or more requests for the IMS DC may comprise sending a first request for the IMS DC with the GETS server and a second request for the IMS DC with the UE.

At 710, the O-TAS may receive response(s) to the one or more requests from the IMS DC node.

At 712, the O-TAS may send messages to the UE and the GETS server inviting the UE and the GETS server to the IMS DC. At 714, the first request (for the IMS DC with the GETS server) may be sent before sending the messages inviting the GETS server and the UE to the IMS DC, and the second request (for the IMS DC with the UE) may be sent after sending the messages inviting the GETS server and the UE to the IMS DC.

At 716, the O-TAS may establish the IMS DC with the O-TAS, the GETS server, and the UE.

In some implementations, the communications with and from the IMS DC node may use HTTP/JSON as part of an SBI.

Further, the operations shown in FIG. 7 and described herein may enable the UE to provide a PIN and destination number to the GETS server for authentication via the IMS DC.

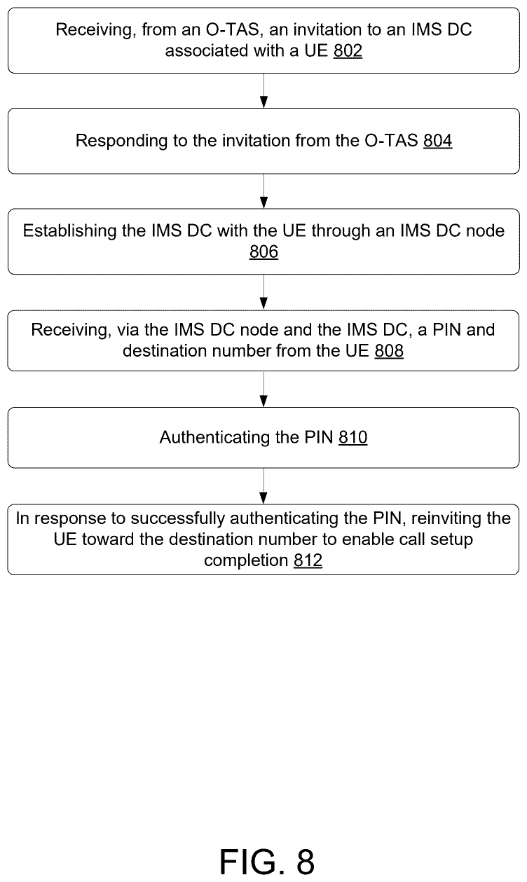

FIG. 8 is a flow diagram of an illustrative process for a GETS server to receive from an O-TAS an invitation to an IMS DC with a UE, establish the IMS DC with the UE through an IMS DC node, receive a PIN and destination number from the UE through the IMS DC, authenticate the PIN, and reinvite the UE toward a call with the destination number. At 802, the GETS server may receive from an O-TAS an invitation to an IMS DC associated with a UE.

At 804, the GETS server may respond to the invitation from the O-TAS.

At 806, the GETS server may establish the IMS DC with the UE through an IMS DC node.

At 808, the GETS server may receive, via the IMS DC node and the IMS DC, a PIN and destination number from the UE.

At 810, the GETS server may authenticate the PIN.

At 812, the GETS server, in response to successfully authenticating the PIN, may reinvite the UE toward the destination number to enable call setup completion.

In some implementations, the communications with and from the IMS DC node may use HTTP/JSON as part of an SBI.

FIG. 9 is a flow diagram of an illustrative process for an IMS DC node to establish an IMS DC among at least a UE and a GETS server in response to communications from an O-TAS and, through the IMS DC, to receive a PIN and destination number from the UE and to send the PIN and destination number to the GETS server.

At 902, the IMS DC node may receive from an O-TAS one or more requests for an IMS DC with at least a GETS server and a UE. At 904, receiving the one or more requests for the IMS DC comprises receiving a first request for the IMS DC with the GETS server and a second request for the IMS DC with the UE.

At 906, the IMS DC node may respond to the O-TAS to cause the O-TAS to send messages to at least the UE and the GETS server inviting the UE and the GETS server to the IMS DC. At 908, responding to the O-TAS to cause the O-TAS to send messages to at least the UE and the GETS server may be responsive to the first request. In some implementations, the second request (for the IMS DC with the UE) may be received after responding to the O-TAS.

At 910, the IMS DC node may establish the IMS DC with at least the UE and the GETS server. At 912, the IMS DC node may send a GETS application to the UE as part of establishing the IMS DC. At 914, the IMS DC node may send at least one of a biometric standard or the PIN as part of establishing the IMS DC. At 916, the establishing may comprise establishing the IMS DC with the UE, the GETS server, and the O-TAS.

At 918, the IMS DC node may receive from the UE and through the IMS DC a PIN and destination number.

At 920, the IMS DC node may send to the GETS server and through the IMS DC the PIN and the destination number.

In various implementations, messages associated with performing the operations shown in FIG. 9 and described herein may use HTTP/JSON as part of an SBI.

FIG. 10 is a schematic diagram of a computing device capable of implementing functionality of at least one of the UE, the O-TAS, the GETS server, or the IMS DC node. As shown, the computing device 1000 includes a memory 1002 storing modules and data 1004, processor(s) 1006, transceivers 1008, and input/output devices 1010.

In various examples, the memory 1002 can include system memory, which may be volatile (such as RAM), non-volatile (such as ROM, flash memory, etc.) or some combination of the two. The memory 1002 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store the desired information.

The memory 1002 can include one or more software or firmware elements, such as computer-readable instructions that are executable by the one or more processors 1006. For example, the memory 1002 can store computer-executable instructions associated with modules and data 1004. The modules and data 1004 can include a platform, operating system, and applications, and data utilized by the platform, operating system, and applications. Further, the modules and data 1004 can implement any of the functionality for the devices and components described and illustrated herein.

In various examples, the processor(s) 1006 can be a central processing unit (CPU), a graphics processing unit (GPU), or both CPU and GPU, or any other type of processing unit. Each of the one or more processor(s) 1006 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 1006 may also be responsible for executing all computer applications stored in the memory 1002, which can be associated with types of volatile (RAM) and/or nonvolatile (ROM) memory.

The transceivers 1008 can include modems, interfaces, antennas, Ethernet ports, cable interface components, and/or other components that perform or assist in exchanging wireless communications, wired communications, or both.

While the computing device need not include input/output devices 1010, in some implementations it may include one, some, or all of these. For example, the input/output devices 1010 can include a display, such as a liquid crystal display or any other type of display. For example, the display may be a touch-sensitive display screen and can thus also act as an input device or keypad, such as for providing a soft-key keyboard, navigation buttons, or any other type of input. The input/output devices 1010 can include any sort of output devices known in the art, such as a display, speakers, a vibrating mechanism, and/or a tactile feedback mechanism. Output devices can also include ports for one or more peripheral devices, such as headphones, peripheral speakers, and/or a peripheral display. The input/output devices 1010 can include any sort of input devices known in the art. For example, input devices can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

Although features and/or methodological acts are described above, it is to be understood that the appended claims are not necessarily limited to those features or acts. Rather, the features and acts described above are disclosed as example forms of implementing the claims.

Also, while the descriptions provided herein may be in the context of certain radio access technologies, networks, and network topologies, such as Fifth Generation (5G)/new radio (NR) mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and NTN communications. Thus, the scope of the disclosure is not limited to the examples described herein.

What is claimed is:

1. A method comprising:
receiving, by an originating telephony application server (O-TAS), a call initiation message associated with a call by a user equipment (UE) to a government emergency telecommunications service (GETS) number;
sending, by the O-TAS, one or more requests for an Internet protocol multimedia subsystem (IMS) data channel (DC) associated with at least the UE and a GETS server to an IMS DC node;
receiving, by the O-TAS, response(s) to the one or more requests from the IMS DC node; and
sending, by the O-TAS, messages to the UE and the GETS server inviting the UE and the GETS server to the IMS DC to enable the UE to provide a personal identification number (PIN) and destination number to the GETS server for authentication via the IMS DC.

2. The method of claim 1, wherein sending the one or more requests comprises sending the one or more requests in response to determining that the GETS server supports IMS DC.

3. The method of claim 2, further comprising, when the GETS server does not support IMS DC, responding to the call initiation message by requesting that the UE enter the PIN.

4. The method of claim 1, wherein communications with the IMS DC node use Hypertext Transfer Protocol (HTTP)/JavaScript Object Notation (JSON).

5. The method of claim 1, wherein the sending the one or more requests for the IMS DC comprises sending a first request for the IMS DC with the GETS server and a second request for the IMS DC with the UE.

6. The method of claim 5, wherein the first request is sent before sending the messages inviting the GETS server and the UE to the IMS DC and the second request is sent after sending the messages inviting the GETS server and the UE to the IMS DC.

7. The method of claim 1, further comprising establishing the IMS DC with the O-TAS, the GETS server, and the UE.

8. A system comprising:
one or more processors; and
a government emergency telecommunications service (GETS) server configured to be operated by the one or more processors to perform operations including:
receiving, from an originating telephony application server (O-TAS), an invitation to an Internet protocol multimedia subsystem (IMS) data channel (DC) associated with a user equipment (UE);
establishing the IMS DC with the UE through an IMS DC node;
receiving, via the IMS DC node and the IMS DC, a personal identification number (PIN) and destination number from the UE;
authenticating the PIN; and
in response to successfully authenticating the PIN, reinviting the UE toward the destination number to enable call setup completion.

9. The system of claim 8, wherein message(s) the establishing and the receiving the PIN and the destination number use Hypertext Transfer Protocol (HTTP)/JavaScript Object Notation (JSON).

10. The system of claim 8, wherein the operations further comprise responding to the invitation from the O-TAS.

11. A non-transitory computer storage medium having programming instructions stored thereon that, when executed by one or more processors of an Internet protocol multimedia subsystem (IMS) data channel (DC) node, cause the IMS DC node to perform operations comprising:
receiving, from an originating telephony application server (O-TAS), one or more requests for an IMS DC with at least a government emergency telecommunications service (GETS) server and a user equipment (UE);
responding to the O-TAS to cause the O-TAS to send messages to at least the UE and the GETS server inviting the UE and the GETS server to the IMS DC;
establishing the IMS DC with at least the UE and the GETS server;
receiving from the UE and through the IMS DC a personal identification number (PIN) and destination number; and
sending to the GETS server and through the IMS DC the PIN and the destination number.

12. The non-transitory computer storage medium of claim 11, wherein the operations further comprise sending a GETS application to the UE as part of establishing the IMS DC.

13. The non-transitory computer storage medium of claim 11, wherein the operations further comprise sending at least one of a biometric standard or the PIN as part of establishing the IMS DC.

14. The non-transitory computer storage medium of claim 11, wherein messages associated with performing the operations use Hypertext Transfer Protocol (HTTP)/JavaScript Object Notation (JSON).

15. The non-transitory computer storage medium of claim 11, wherein receiving the one or more requests for the IMS DC comprise receiving a first request for the IMS DC with the GETS server and a second request for the IMS DC with the UE.

16. The non-transitory computer storage medium of claim 15, wherein responding to the O-TAS to cause the O-TAS to send messages to at least the UE and the GETS server is responsive to the first request.

17. The non-transitory computer storage medium of claim 16, wherein the second request is received after responding to the O-TAS.

18. The non-transitory computer storage medium of claim 11, wherein the establishing comprises establishing the IMS DC with the UE, the GETS server, and the O-TAS.
